(19) United States
(12) Patent Application Publication
(10) Pub. No.: US 2014/0373954 A1
(43) Pub. Date: Dec. 25, 2014

(54) Pipe Insulation System and Method

(71) Applicant: Strom W. Smith, Gulfport, MS (US)

(72) Inventor: Strom W. Smith, Gulfport, MS (US)

(21) Appl. No.: 14/312,183

(22) Filed: Jun. 23, 2014

Related U.S. Application Data
(60) Provisional application No. 61/838,760, filed on Jun. 24, 2013.
(60) Provisional application No. 61/845,644, filed on Jul. 12, 2013.
(60) Provisional application No. 62/011,099, filed on Jun. 12, 2014.

(51) Int. Cl. F16L 53/00; F16L 59/14; F16L 59/08; F16L 59/02; F16L 59/04

(52) U.S. Cl. CPC F16L 53/002; F16L 53/008; F16L 59/029; F16L 59/04; F16L 59/08; F16L 59/141
USPC 138/33; 138/32; 138/148; 138/149

(57) ABSTRACT

An insulation system for process vessels or piping. In one embodiment, a first sheath having a heat-reflective coating on an inner surface thereof is spaced from a structure. A second outer sheath is provided exterior to the first sheath. An insulation layer is provided intermediate the sheaths. In another embodiment, an outer sheath has insulation disposed on an inner surface thereof, the insulation being intermediate the inner surface and the structure and is spaced therefrom. A liner having a heat-reflective coating on an inner surface thereof is provided on the inner surface of the insulation. In another embodiment, a reflective metal foil is wrapped around a structure which may be equipped with an external heating means. A shell having an inner heat-reflective surface is disposed circumferentially to the structure, with an air gap there between. Disposed exterior to the shell is insulation, and optionally, a protective coating and/or second shell.

### CROSS-REFERENCE TO RELATED APPLICATIONS

This application claims the benefit of U.S. Provisional Application No. 61/838,760 filed on Jun. 24, 2013, U.S. Provisional Application No. 61/845,644 filed on Jul. 12, 2013, and United States Provisional Application No. 62/011,099 filed on Jun. 12, 2014, which applications are incorporated herein by reference as if reproduced in full below.

### STATEMENT REGARDING FEDERALLY SPONSORED RESEARCH OR DEVELOPMENT

Not applicable.

### BACKGROUND OF THE INVENTION

1. Field of the Invention

The present invention relates generally to pipe insulation systems. More particularly, the present invention relates to a system and method for insulating industrial and process piping.

2. Description of the Related Art

Insulation systems are commonly practiced for industrial piping and vessels. Some insulation systems include heat tracing systems utilizing heating elements to maintain or raise temperatures of pipes and vessels. Heat tracing may take the form of an electrical heating element run in physical contact along the length of a pipe. In industrial applications, heat tracing may be accomplished by circulating steam or another fluid through pipes or tubes adjacent the pipe or vessel to be heated. In other industrial applications, electrical impedance type heating is employed, wherein terminals are attached to each end of a pipe, and a low voltage current is passed through it. The pipe thus acts as its own heating element.

The heated pipe or vessel is covered with thermal insulation to retain heat losses from the pipe. Heat generated by whatever means maintains the temperature of the pipe. Such heating is often used to maintain existing temperatures in a piping system when the contents are subject to solidification at ambient temperatures.

### BRIEF SUMMARY OF THE INVENTION

An exemplary embodiment of the present invention comprises an insulation system for process vessels or piping comprising a first sheath spaced from a pipe or vessel. A heat-reflective coating is applied to the inner surface of the sheath. A second outer sheath is provided exterior of the first sheath. An insulation layer is provided intermediate the first sheath and the second sheath. In an exemplary embodiment, an aerogel is placed intermediate the inner sheath and the outer sheath.

Another exemplary embodiment of the present invention comprises an insulation system for process vessels or piping comprising an outer sheath with insulation fixedly attached to an inner surface of the outer sheath. Accordingly, insulation is disposed intermediate the inner surface and the pipe or vessel and is spaced therefrom. A liner is provided on the inner surface of the insulation. A heat-reflective coating is provided on the inner surface of the liner.

Another exemplary embodiment of the present invention comprises an insulation system for process vessels or piping comprising a reflective metal foil wrapped around a pipe or vessel equipped with an external (to the pipe or vessel) heating means. A shell comprising an insulating material, such as aluminum, is disposed circumferentially to the foil wrapped pipe or vessel, with an air gap there between. The interior surface of the shell comprises a heat-reflective surface. Disposed exterior to the shell are one or more layers of an insulation material, such as an aerogel. A protective coating or a second shell may be applied around the outermost layer of insulation material.

### BRIEF DESCRIPTION OF THE DRAWINGS

FIG. 1 is an exemplary insulation system of the present invention.

FIG. 2 is an exemplary alternative insulation system of the present invention.

FIG. 3 is an exemplary alternative insulation system of the present invention.

FIG. 4 is an exemplary alternative insulation system of the present invention.

FIG. 5 is an exemplary alternative insulation system of the present invention.

### DESCRIPTION OF THE INVENTION

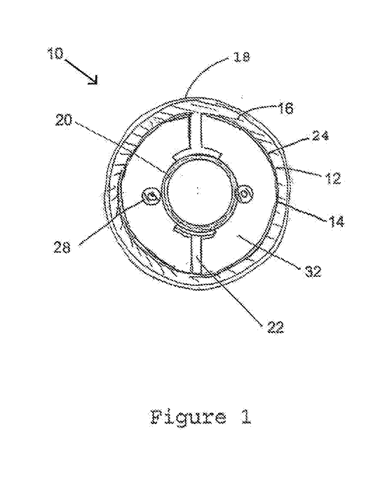

Referring to FIG. 1, there is shown an embodiment of a pipe insulation system 10 of the present invention. In the exemplary embodiment of FIG. 1, the pipe 20 to be insulated is depicted. System 10 of the present invention comprises an inner sheath 12 having a heat-reflective coating 14, an outer sheath 18, and an aerogel 16 intermediate inner sheath 12 and outer sheath 18.

Inner sheath 12 is spaced from pipe 20. In an exemplary embodiment, such spacing is in a range of 1 cm to 5 cm. Inner surface 24 of inner sheath 12, being the surface of inner sheath 12 proximate pipe 20, is coated with a heat-reflective coating 14. In an exemplary embodiment, coating 14 is a heat-reflective paint having reflectance of at least 0.70. In a further exemplary embodiment, coating 14 contains hollow ceramic spheres to enhance insulation. In a further exemplary embodiment, coating 14 further contains reflective metallic elements, such as reflective aluminum flakes. In another exemplary embodiment of the invention (not shown), inner sheath 12 comprises a heat-reflective inner surface 24 in lieu of a heat-reflective coating 14.

Aerogel 16 is sandwiched between inner sheath 12 and outer sheath 18. In an exemplary embodiment, aerogel 16 is a silica aerogel. Other non-metallic aerogels may be utilized. Any suitable insulation, including but not limited to, conventional insulation as is generally known in the art may be used in lieu of aerogel 16.

Spacers 22 are provided intermediate the exterior of pipe 20 and inner surface 24 of inner sheath 12 to maintain spatial distance between inner sheath 12 and pipe 20. Annular space 32 is defined between the exterior of pipe 20 and inner sheath 12. In other embodiments (not shown), spatial distance between pipe 20 and inner sheath 12 may be maintained by means other than spacers 22, such as but not limited to, connection, directly or indirectly, of a portion of inner sheath 12 to pipe components such as flanges, or connection, directly or indirectly, of inner sheath 12 to external support structures.

Heating elements 28 are provided proximate pipe 20 within space 32. In an exemplary embodiment, heating elements 28 comprise tubes capable of circulating a fluid such as steam. In a second exemplary embodiment, heating elements 28 comprise heat tape. In another exemplary embodiment of the invention (not shown), pipe 20 is heated by electrical impedance means and no exterior heating elements 28 are provided. In an exemplary embodiment, inner sheath 12 is constructed of a metal alloy, such as an aluminum alloy or a steal alloy, and outer sheath 18 is constructed of a metal alloy, such as an aluminum alloy or a steel alloy.

### Exemplary Calculation of Heat Loss:

In an exemplary calculation of heat loss from an insulation system 10 of the present invention together with steam tracing heat elements 28, the following assumptions are adopted:
2″ pipe 20 (2.375″ outside diameter).
Emissivity of pipe 20=0.8.
50 p.s.i. steam tracing (298° Fahrenheit) of heating elements 28.
1″ space between pipe 20 and inner surface 24 of inner sheath 12.
Aerogel 16 emissivity: k=0.15 at 300 degrees Fahrenheit. An exemplary source of such an aerogel 16 material is a silica aerogel available from Aspen Aerogels, Inc. and/or Aerogel Technologies, LLC and marketed as Pyrogel® or equivalents thereof.
Inner sheath coating 14 having a reflectance of 0.74. An exemplary commercial source of a coating 14 is a ceramic-aluminum barrier coating available from Hy-Tech Thermal Solutions, LLC or equivalents thereof.

Calculation:

Utilizing the foregoing assumptions, the following calculation of estimated heat loss from system 10 is made:

$$Q = \frac{0.173}{( \frac{1}{{K}_{1}} ) + ( \frac{1}{{K}_{2}} ) - 1} \times [ ( \frac{{T}_{1}^{4}}{100} ) - ( \frac{{T}_{2}^{4}}{100} ) ]$$

Wherein:

K₁=0.8;

K₂=0.28;

T₁=758° R; and

T₂=492° R.

Q, the calculated heat loss, is less than 123 BTU/hour/lineal pipe foot.

A method of insulating a pipe or vessel comprises the following steps:

providing a heat-reflective coating on an inner sheath;

placing the sheath over the vessel or pipe structure to be insulated with the heat-reflective coating facing the structure;

providing a spacer to maintain separation of the sheath from the structure, such spacing to be at least 2 cm;

providing an outer sheath spaced from the inner sheath and distal the structure; and

providing an insulator intermediate the outer sheath and the inner sheath.

In an exemplary embodiment, the heat-reflective coating comprises a coating having hollow ceramic spheres. In another exemplary embodiment, the heat-reflective coating contains reflective metallic elements, such as reflective aluminum flakes. In an exemplary embodiment, the insulator comprises an aerogel. In a further exemplary embodiment, the insulator comprises a silica aerogel. In a further exemplary embodiment, a step of providing at least one heat tracing element intermediate the structure and the inner sheath is provided.

### Alternative Embodiment

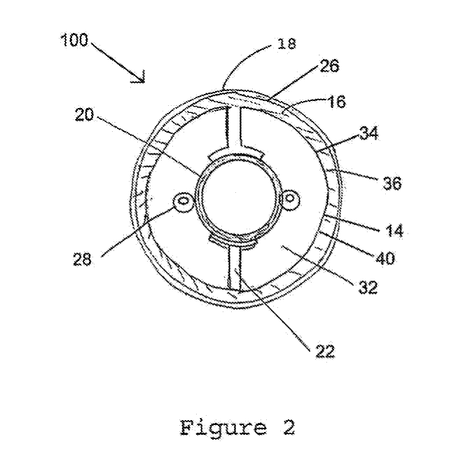

Referring to FIG. 2, there is shown an alternative embodiment of a pipe insulation system 100 of the present invention. In the exemplary embodiment of FIG. 2, the pipe 20 to be insulated is depicted. System 100 of the present invention comprises an outer sheath 18 with an aerogel 16 fixedly attached to an inner surface 26 of outer sheath 18. Accordingly, aerogel 16 is disposed intermediate inner surface 26 and pipe 20 and is spaced from pipe 20. A liner 34 is provided on inner surface 36 of aerogel 16. A heat-reflective coating 14 is provided on inner surface 40 of liner 34. In another exemplary embodiment of the invention (not shown), liner 34 comprises a heat-reflective inner surface 40 in lieu of a heat-reflective coating 14. In this aspect, inner surface 40 comprises a heat-reflective layer.

In an exemplary embodiment, aerogel 16 is attached to inner surface 26 of outer sheath 18 by an adhesive (not shown). In another exemplary embodiment, aerogel 16 may be provided on or proximate inner surface 26 of outer sheath 18 without being fixedly attached thereto. In an exemplary embodiment, liner 34 may be a fabric material, a foil, or other relatively thin material. In an exemplary embodiment, liner 34 may be attached to inner surface 36 of aerogel 16 by an adhesive (not shown). In another exemplary embodiment, liner 34 may be provided on or proximate inner surface 36 of aerogel 16 without being fixedly attached thereto.

Heat-reflective coating 14 is spaced from pipe 20. In an exemplary embodiment, such spacing is in a range of 1 cm to 5 cm. In an exemplary embodiment, coating 14 is a heat-reflective paint having reflectance of at least 0.70. In a further exemplary embodiment, coating 14 contains hollow ceramic spheres to enhance insulation. In a further exemplary embodiment, coating 14 further contains reflective metallic elements, such as reflective aluminum flakes.

In a further exemplary embodiment, coating 14 comprises small-diameter ceramic spheres attached to liner 34 by an adhesive. In a further exemplary embodiment, coating 14 comprises a high-gloss metallic foil attached to liner 34. In a further exemplary embodiment, liner 34 is not provided and heat-reflective coating 14 is attached directly to inner surface 36 of aerogel 16. In an exemplary embodiment, aerogel 16 is a silica aerogel. Other aerogels may be utilized. Any suitable insulation, including but not limited to, conventional insulation as is generally known in the art may be used in lieu of aerogel 16.

Spacers 22 are provided intermediate the exterior of pipe 20 and inner surface 36 of aerogel 16 to maintain spatial distance between inner surface 36 and pipe 20. Annular space 32 is defined between the exterior of pipe 20 and inner surface 36. In other embodiments (not shown), spatial distance between pipe 20 and inner sheath 12 may be maintained by means other than spacers 22, such as but not limited to, connection, directly or indirectly, of a portion of insulation 16 and/or liner 34 to pipe components such as flanges, or connection, directly or indirectly, of insulation 16 and/or liner 34 to external support structures.

Heating elements 28 may be provided proximate pipe 20 within space 32. In an exemplary embodiment, heating elements 28 comprise tubes capable of circulating a fluid such as steam. In a further exemplary embodiment, elements 28 comprise heat tape. In another exemplary embodiment of the invention (not shown), pipe 20 is heated by electrical impedance means and no exterior heating elements 28 are provided. In an exemplary embodiment, outer sheath 18 is constructed of a metal alloy, such as an aluminum alloy or a steel alloy.

An embodiment of an alternative system for insulating a pipe or process vessel structure comprises a heat-reflective layer; said heat-reflective layer spaced from said structure; said heat-reflective layer having an inner surface facing said structure; an outer sheath; said heat-reflective layer intermediate said structure and said outer sheath; and an insulator intermediate said heat-reflective layer and said outer sheath.

An alternative method of insulating a pipe or vessel comprises the following steps:

providing an aerogel on an inner surface of a sheath;

providing a liner on the inner surface of the aerogel;

providing a spacer to maintain separation of the liner from a pipe to be insulated;

providing a heat-reflective coating on the inner surface of the liner; and

placing the sheath, the liner, and the heat-reflective coating around a pipe to be insulated, with an annular space between the liner and the pipe defined at least in part by the spacer.

### Alternative Embodiment

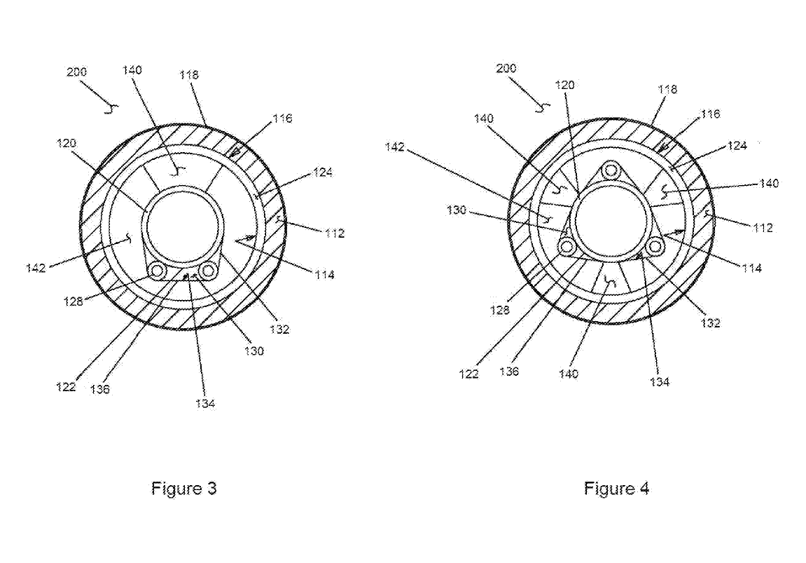

Referring to FIG. 3, there is shown an embodiment of a pipe insulation system 200 of the present invention. In the exemplary embodiment of FIG. 3, a pipe 120 to be insulated is depicted. System 200 of the present invention comprises one or more heating elements 128 provided exterior to pipe 120 and proximate an exterior surface 122 thereof. In an exemplary embodiment of the present invention shown in FIG. 3, two heating elements 128 are provided. In a second exemplary embodiment of the present invention shown in FIG. 4, three heating elements 128 are provided. In an exemplary embodiment of the present invention, heating elements 128 comprise tubes capable of circulating a fluid such as, but not limited to, steam. In a second exemplary embodiment, heating elements 128 utilize electric energy and may comprise a heat tape as is generally known in the art. In another embodiment of the present invention (not shown), pipe 120 is heated by electrical impedance means and no exterior heating elements 128 are provided. The above listed heating methods and means are only exemplary, and one skilled in the art would understand that the present invention is applicable to insulation of any suitable pipe or vessel, and therefore may be used with pipes or vessels heated by other processes.

In one embodiment of the present invention, pipe 120 has an outer diameter of about 4.5 inches and a thickness of about 0.237 inches, and heating elements 128 comprise tubes adapted to provide fluid flow of steam. One skilled in the art would understand that various embodiments of the present invention could utilize pipes 120 (or vessels) having different diameters and thicknesses.

In an exemplary embodiment of the present invention, a metal foil 132 is wrapped around pipe 120 and heating elements 128. In an exemplary embodiment of the present invention, metal foil 132 comprises aluminum. Metal foil 132 as utilized in the present invention comprises a heat-reflective (sometimes “shiny”) surface 134 that faces pipe 120 and heating elements 128. A metal foil 132 having any suitable thickness (gauge) may be employed in the present invention. In one embodiment of the present invention, metal foil 132 has a thickness of less than about than 0.2 millimeters. In one embodiment of the present invention, metal foil 132 comprises aluminum and has a thickness of between about 0.016 millimeters and about 0.024 millimeters.

In an exemplary embodiment of the present invention, application of metal foil 132 is achieved by wrapping in an angled manner so as to provide the ability to only partially overlap metal foil 132 on itself. In this fashion, metal foil 132 is provided spirally along the length of pipe 120. The angle of spirality may be varied to provide a desired wrapping geometry such that one or more layers of metal foil 132 are provided at substantially all locations along pipe 120. In one embodiment of the present invention, metal foil 132 is wrapped around pipe 120 and heating elements 128 in such a manner that an overall layer count of about 6 to 8 layers is provided. In addition, the metal foil 132 wrapping may be repeated (over previously applied metal foil wrapping) as many times as needed to achieve a desired overall metal foil 132 thickness from multiple wrappings.

Spaces or gaps 130 define a region exterior to heating elements 128 and intermediate exterior surface 122 of pipe 120 and heat-reflective surface 134 of metal foil 132. Not to be limited by theory, it is believed that heat-reflective surface 134 reflects thermal radiation emanating from heating elements 128 back toward pipe 120, and metal foil 132 conducts heat there through, thereby distributing heat around pipe 120. Depending on the number of heating elements 128 and the dimensions thereof, the number and dimensions of gaps 130 will vary. In the embodiments of the present invention depicted by FIG. 3 and FIG. 4, the number and placement of heating elements 128 results in direct contact between portions of exterior surface 122 of pipe 120 and portions of heat-reflective surface 134 of metal foil 132. Other embodiments of the present invention may comprise a number and placement of heating elements 128 that results in fewer or no points of contact between exterior surface 122 of pipe 120 and heat-reflective surface 134 of metal foil 132. In still another embodiment of the present invention (not shown), wherein pipe 120 is heated by electrical impedance and no heating elements 128 are provided, substantially all of heat-reflective surface 134 of metal foil 132 is in direct contact with exterior surface 122 of pipe 120.

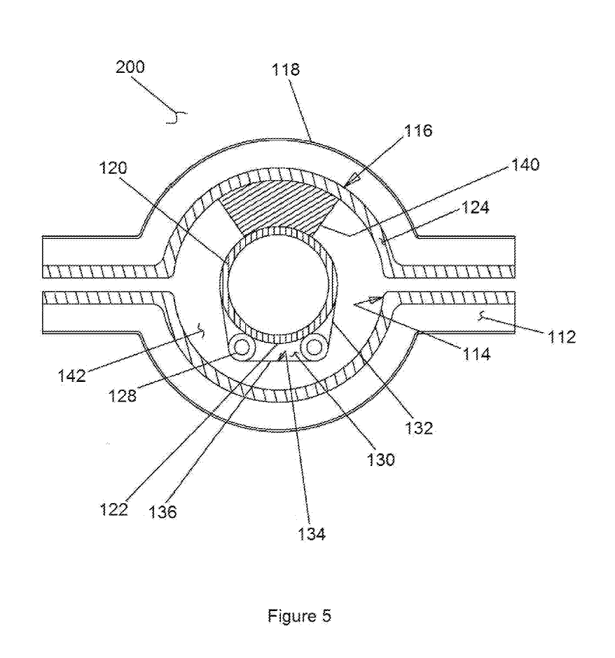

In an exemplary embodiment of the present invention, exterior to an outer surface 136 of metal foil 132, one or more spacers 140 are provided to maintain spatial distance from a shell 124 disposed circumferentially to the foil wrapped pipe 120 and heating elements 128. FIG. 5 depicts a spacer 140 in more detail. In other embodiments (not shown), spatial distance between shell 124 and outer surface 136 of metal foil 132 may be maintained by means other than spacers 140, such as but not limited to, connection of a portion of shell 124 to pipe components such as flanges, or connection, directly or indirectly, of shell 124 to external support structures.

In an exemplary embodiment, shell 124 is constructed of a metal or metal alloy, such as an aluminum alloy or a steel alloy. In one embodiment of the present invention, shell 124 comprises aluminum. Shell 124 comprises a heat-reflective inner surface 114. In one embodiment, heat-reflective inner surface 114 is polished to improve heat reflection. In one embodiment, a heat-reflective coating (not shown) may be applied to heat-reflective inner surface 114 to improve heat reflection. In an exemplary embodiment, the heat-reflective coating is a heat-reflective paint having reflectance of at least 0.70. In a further exemplary embodiment, the heat-reflective coating may contain hollow ceramic spheres to enhance insulation. In a further exemplary embodiment, the coating further comprises reflective metallic elements (i.e., materials), such as reflective aluminum flakes. An exemplary commercial source of a heat-reflective coating is a ceramic-aluminum barrier coating available from Hy-Tech Thermal Solutions, LLC or equivalents thereof.

Intermediate outer surface 136 of metal foil 132 and an inner surface 114 of shell 124 is an annular space or gap 142. Based on the external dimensions of metal foil wrapped pipe 120 (and heating elements 128), and the internal dimensions of shell 124, the dimensions of annular space 142 will vary. As is depicted in FIG. 3, annular space 142 may not comprise symmetrical dimensions. In one embodiment of the present invention, annular space 142 provides a minimum of 0.75 inches between outer surface 136 of metal foil 132 and inner surface 114 of shell 124.

Exterior to shell 124 is provided insulating material 112. In one embodiment of the present invention, insulating material 112 comprises an aerogel. In an exemplary embodiment, insulating material 112 comprises a silica aerogel. In one aspect, the aerogel has an emissivity of k=0.15 at 300 degrees Fahrenheit. An exemplary source of such an aerogel material is a silica aerogel available from Aspen Aerogels, Inc. and/or Aerogel Technologies, LLC and marketed as Pyrogel® or equivalents thereof. Other non-metallic aerogels may be utilized. Any suitable insulation, including but not limited to, conventional insulation as is generally known in the art may be used in lieu of an aerogel.

Shell 124 may any comprise any thickness suitable to provide desired support and/or insulating properties. Shell 124 may comprise a single, substantially tubular structure, or shell 124 may comprise a plurality of sub-structures, as depicted in FIG. 5, that form shell 124 when combined. In one embodiment of the present invention, shell 124 comprises one or more fittings (not shown) adapted to facilitate connection of the pipe insulation system to a support structure (not shown) and/or connection of measurement devices and sensors (not shown) to the pipe insulation system.

Insulating material 112 may be provided as a single layer of material or as a plurality of layers. If multiple layers are utilized, the layers may comprise the same or different insulating materials 112. A layer of insulating material 112 may be affixed to an exterior surface 116 of shell 124. Such affixing may comprise the use of glue or other adhesive. Optional additional layers of insulating material 112 may be affixed to an outer surface of a previously provided insulating material 112 layer. The total thickness of all insulating material 112 may be of any thickness suitable to provide desired insulating properties. In one embodiment of the present invention, insulating material 112 comprises an aerogel having a thickness of about 10 millimeters.

In one embodiment of the present invention, a protective coating (not shown) is applied to an exterior surface 118 of the outermost layer of insulating material 112. In another embodiment of the present invention, a second shell (not shown) may be provided circumferentially to exterior surface 118, either in conjunction with use of a protective coating or in lieu thereof.

As would be understood by one skilled in the art, the heat retention and/or insulating characteristics of the present invention may be optimized based on adjustment of any or all of the above listed parameters.

### EXPERIMENTAL RESULTS

With room temperature (solid) sulfur in a 4 inch (NPS) pipe, a steam generator produced a flow of 60# steam through two tracers. Surface thermocouples were mounted on the pipe, the outside of the aluminum foil, and on the outside of the shell (underneath the insulation). The foil was spiral wrapped and had approximately 6 layers. Ten millimeters of insulation was applied to the outside of the shell. The foil temperature rose to 200 degrees Fahrenheit in 5 minutes, and the temperature gain thereafter flattened out, reaching a maximum of 262 degrees Fahrenheit. The pipe temperature rose steadily—climbing to the melting point of sulfur of 248 degrees Fahrenheit in less than 60 minutes. The pipe temperature maxed out at 278 degrees Fahrenheit. Liquid sulfur was exiting a hole at the midpoint of the pipe at 1.5 hours.

### Method

Another alternative method of insulating a pipe or vessel structure equipped with one or more external heating elements comprises the following steps:

wrapping the structure and the external heating elements with a metal foil comprising a heat-reflective surface, wherein the wrapping provides the heat-reflective surface facing the pipe or vessel and the external heating elements;

providing one or more spacers exterior to the metal foil;

providing circumferentially to the metal foil wrapped structure a shell comprising a heat-reflective inner surface, whereby the one or more spacers maintain separation of the shell from the metal foil wrapped structure;

providing insulating material exterior to the shell; and

(optionally) providing a protective coating on, and/or a second shell circumferential to, the exterior surface of the insulating material.

In another embodiment of a method of the present invention (not shown), a structure not equipped with external heating elements is insulated by wrapping the structure with a metal foil comprising a heat-reflective surface, wherein the wrapping provides the heat-reflective surface facing the pipe or vessel. In another embodiment of a method of the present invention (not shown), no spacers are provided and a shell comprising a heat-reflective inner surface provided circumferentially to the metal foil wrapped structure is maintained in separation from the metal foil wrapped structure by another means, such as connection of a portion of the shell to pipe components such as flanges, or connection, directly or indirectly, of the shell to an external support structure.

Embodiments of the present invention, including but not limited to alternative embodiments disclosed herein, are applicable to insulation of any suitable pipe or vessel that is not separately heated, but rather, contains a material of a desired temperature that need only be maintained at or near that temperature through insulation of the pipe or vessel.

While the present invention has been disclosed and discussed in connection with the foregoing embodiments, it will be understood that the invention is not limited to the embodiments disclosed, but is capable of numerous rearrangements, modifications, and substitutions of parts and elements without departing from the spirit and scope of the invention.

I claim:

1. A system for insulating a pipe, or process vessel, structure comprising:
an inner sheath;
an outer sheath; and
an insulating material;
wherein:
said inner sheath is spaced from said structure, intermediate said structure and said outer sheath;
said inner sheath comprises a heat-reflective inner surface facing said structure; and
said insulating material is disposed intermediate said inner sheath and said outer sheath.

2. The system according to claim 1, wherein said insulating material comprises an aerogel.

3. The system according to claim 1, wherein said inner sheath is spaced from said structure a distance of from about 1 centimeter to about 5 centimeters.

4. The system according to claim 1, wherein said inner sheath comprises aluminum.

5. The system according to claim 1, wherein said heat-reflective inner surface comprises a heat-reflective coating.

6. The system according to claim 5, wherein said heat-reflective coating comprises one or more components selected from the group consisting of:
A. heat-reflective paint;
B. hollow ceramic spheres; and
C. reflective metallic materials.

7. The system according to claim 1, wherein one or more heating elements are disposed intermediate said structure and said inner sheath.

8. The system according to claim 7, wherein said one or more heating elements comprise components selected from the group consisting of:
A. tubes adapted to allow the flow of fluids;
B. an electrical element;
C. both tubes adapted to allow the flow of fluids and an electrical element.

9. The system according to claim 1, further comprising one or more spacers adapted to maintain said inner sheath spaced from said structure.

10. A system for insulating a pipe, or process vessel, structure comprising:
an outer sheath;
an insulating material; and
a heat-reflective surface;
wherein:
said insulating material is disposed intermediate said outer sheath and said heat reflective surface; and
said heat-reflective surface:
is disposed intermediate said insulating material and said structure;
faces said structure; and
is spaced from said structure.

11. The system according to claim 10, wherein said insulating material comprises an aerogel.

12. The system according to claim 10, wherein said heat-reflective surface is spaced from said structure a distance of from about 1 centimeter to about 5 centimeters.

13. The system according to claim 10, wherein said heat-reflective surface comprises a component selected from the group consisting of:
A. a heat-reflective coating applied to an inner surface of said insulating material;
B. a liner fixedly attached to said inner surface of said insulating material; and
C. a heat-reflective coating applied to an inner surface of said liner.

14. The system according to claim 13, wherein said heat-reflective coating comprises one or more components selected from the group consisting of:
A. heat-reflective paint;
B. hollow ceramic spheres; and
C. reflective metallic materials.

15. The system according to claim 13, wherein said liner comprises material selected from the group consisting of:
A. fabric;
B. metal foil; and
C. both fabric and metal foil.

16. The system according to claim 10, wherein one or more heating elements are disposed intermediate said structure and said heat reflective surface.

17. The system according to claim 16, wherein said one or more heating elements comprise components selected from the group consisting of:
A. tubes adapted to allow the flow of fluids;
B. an electrical element;
C. both tubes adapted to allow the flow of fluids and an electrical element.

18. The system according to claim 10, further comprising one or more spacers, wherein said spacers are adapted to maintain said heat-reflective surface spaced from said structure.

19. A system for insulating a pipe, or process vessel, structure comprising:
a metal foil wrapping provided around said structure;
a shell disposed circumferentially to and spaced from said metal foil wrapping; and
insulating material; wherein:
said metal foil comprises a heat-reflective surface facing said structure;
said shell comprises an inner heat-reflective surface facing said metal foil; and
said insulating material is disposed proximate and external to an outer surface of said shell.

20. A method for insulating a pipe, or process vessel, structure comprising:
wrapping said structure with a metal foil;
providing a shell circumferentially to and spaced from said metal foil; and
providing insulating material exterior to said shell; wherein:
said metal foil comprises a heat-reflective surface facing said structure; and
said shell comprises a heat-reflective inner surface facing said metal foil.
